(19) United States
(12) Patent Application Publication
(10) Pub. No.: US 2021/0053320 A1
(43) Pub. Date: Feb. 25, 2021

(54) OPTICAL FILM INCLUDING LAYER OF POLYCARBONATE

(71) Applicant: 3M INNOVATIVE PROPERTIES COMPANY, St. Paul, MN (US)

(72) Inventors: Derek W. Patzman, Savage, MN (US); Kristopher J. Derks, Woodbury, MN (US); Stephen A. Johnson, Woodbury, MN (US); Gary E. Gaides, Woodbury, MN (US)

(21) Appl. No.: 16/967,906

(22) PCT Filed: Feb. 19, 2019
(86) PCT No.: PCT/IB2019/051332

§ 371 Date: Aug. 6, 2020

Related U.S. Application Data
(60) Provisional application No. 62/634,991, filed on Feb. 26, 2018.

(51) Int. Cl. B32B 25/08; G02B 1/14; G02B 5/20; C08L 23/12; B32B 7/06; B32B 7/12; B32B 27/36; B32B 27/08; B32B 27/32; B32B 25/14

(52) U.S. Cl. CPC B32B 25/08; B32B 2457/20; G02B 5/208; C08L 23/12; B32B 7/06; B32B 7/12; B32B 27/365; B32B 27/08; B32B 27/32; B32B 25/14; B32B 2250/24; B32B 2270/00; B32B 2307/412; B32B 2307/732; G02B 1/14

(57) ABSTRACT

Optical films are disclosed. In particular, optical films including a layer of polycarbonate having first and second major surfaces are described. The optical films have excellent bending lifetime properties and also low haze, thinness, and low in-plane and out-of-plane retardation.

### BACKGROUND

Optical films are typically thin layers or multilayer construction that are suitable for or not detrimental to the performance of an optical device. For example, optical films used in display devices should be generally transparent and or not detract significantly from the overall efficiency or brightness of the display device.

### SUMMARY

In one aspect, the present description relates to an optical film. In particular, the present description relates to an optical film including a layer of polycarbonate having first and second major surfaces. The layer is between 10 and 50 micrometers thick and the polycarbonate has a molecular weight greater than 20,000. The optical film, with any peel layers removed, has an average haze less than 0.5%, an average in-plane retardance of less than 25 nm, and an average out-of-plane retardance of less than 75 nm.

### BRIEF DESCRIPTION OF THE DRAWINGS

FIG. 1. is a cross-sectional elevation schematic of a bilayer optical film including a polycarbonate layer.

FIG. 2 is a cross-sectional elevation schematic of another bilayer optical film including a polycarbonate layer.

FIG. 3 is a cross-sectional elevation schematic of a tri-layer optical film including a polycarbonate layer.

FIG. 4 is a cross-sectional elevation schematic of another tri-layer optical film including two layers of polycarbonate.

FIG. 5 is a cross-sectional elevation schematic of another tri-layer optical film including a polycarbonate layer.

FIG. 6 is a cross-sectional elevation schematic of a five-layer optical film including two layers of polycarbonate.

FIG. 7 is a cross-sectional elevation schematic of another five-layer optical film including a polycarbonate layer.

FIG. 8 is a cross-sectional elevation schematic of a seven-layer optical film including two layers of polycarbonate.

FIG. 9 is a cross-sectional elevation schematic of another seven-layer optical film including four layers of polycarbonate.

### DETAILED DESCRIPTION

Cyclic olefin polymers (COP) are commonly used in optical applications for their desirable optical properties, such as low haze and low birefringence. Certain physical properties, such as workable thinness and high glass transition temperature (Tg) are also desirable in many processes and designs. However, the cost of COP is often prohibitive, costing ten times or even more than other transparent polymers. Previously, lower cost substitutes for COP in optical applications were undesirable because 1) the material could not be formed in a film at the desired thickness with the desired optical isotropy and transparency and/or 2) the materials used in the film have physical characteristics such as glass transition temperature that are unsuitable for processing environments associated with current uses of COP.

Many common polymers, such as polyesters including polyethylene terephthalate and polyethylene naphthalate develop unacceptable levels of birefringence when processed or stretched in manufacturing. With recent interest in flexible, foldable, and rollable displays and devices, these incumbent polymers (including COP) fail under bend testing prematurely, making them unsuitable for use in these applications.

Polycarbonate is known for its optical isotropy (low inherent and stress-imparted birefringence) and high glass transition temperature (about 147° C.); however, it is difficult to process at desirable thicknesses without imparting haze to the film. Previously, polycarbonate was not used in these applications, or the thickness of polycarbonate was increased such that it could be handled and processed without haze and/or birefringence.

In some embodiments, polycarbonate films can be coprocessed with other layers of material in order to allow for high-yield processing and handling with the polycarbonate exhibiting the desired optical performance in a thin form. The additional layers may impart certain optical functionalities, such as the absorption of UV light, or they may be selected or designed to be removable or peelable in order to allow the bare polycarbonate to be incorporated into film stacks and in other applications. Alternatively or additionally, peelable layers may be included to manufacture several optical films simultaneously, with the film peeled apart later to separate it into the desired individual units.

Such films may be useful in many optical applications, including emissive displays, touch modules, reflective displays, transflective displays, liquid crystal displays, passive displays, and the like.

Particularly suitable for applications described herein are polycarbonates with high average molecular weight. Previously, it was believed that these high molecular weight polycarbonates would result in unacceptable birefringence; however, surprisingly, given the configurations of optical films described herein, such polycarbonates can be processed with low haze and low birefringence, while the high molecular weight used allows for robust films that can withstand more folding than alternatives.

Many configurations are possible and may be selected depending on the particular application. For example, in the simplest form, a layer of polycarbonate is processed along with a second layer. In some embodiments, this layer is a release, strippable, or peelable layer. In some embodiments, this layer is a layer of a different polymer or polymer blend. In some embodiments, the different material may impart desirable physical or optical properties to the optical film, including a textured or structured surface to the polycarbonate layer. In some embodiments, the additional layer is a coating, such as a vapor barrier, a hardcoat, an elastic memory layer. In some embodiments, the additional layer is a patterned conductive layer such as indium tin oxide or copper or silver metal mesh, or a layer of silver nanowires (for example, to enable the use of such a layer as a capacitive touch sensor).

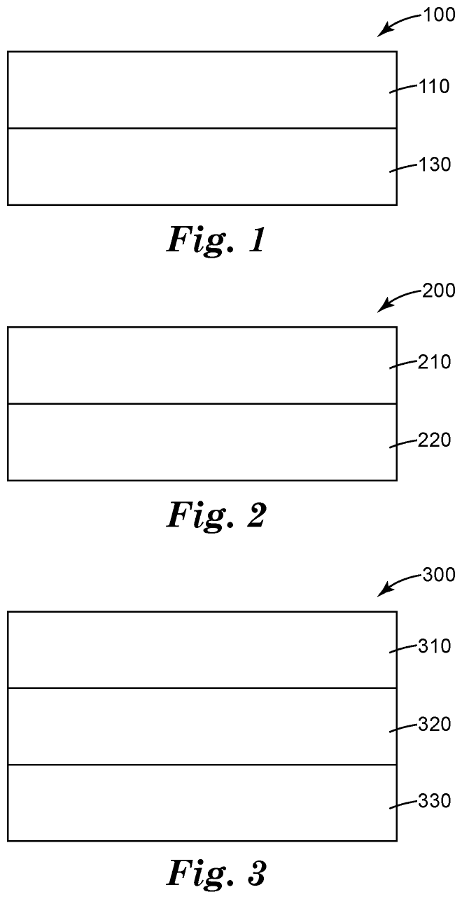

In the example of FIG. 1, optical film 100 includes polycarbonate layer 110 disposed on peel layer 130. Peel layer may be selected to be any material or set of materials that can be cleanly removable along the interface between the polycarbonate layer and the peel layer. In some embodiments, peel layer may have an adhesion of less than 40 g/in, less than 10 g/in, or less than 5 Win. For example, polyolefins, such as polypropylene, sets of materials including polyolefins, or fluoropolymers or sets of materials including fluoropolymers may be used. In certain embodiments, these layers are co-polypropylene and a styrene block copolymer, for example, SEBS/SEPS block copolymers. In certain embodiments, these layers are a blend including polycarbonate and a SEBS/SEPS block copolymer. After the film is processed and delivered, including possibly being converted into the shape and size of a desired part, the peel layer may be separated from the polycarbonate layer and discarded, recycled, or perhaps used in an unrelated construction or application. In certain applications, even though the layer may be peelable or removeable, it may be kept on as either a protective layer, shock resistant layer, or wear layer, or simply to improve the physical characteristics of the overall optical film. In some embodiments, the peel layer includes an antistatic agent, which may aid in the electrostatic pinning process during the optical film's casting. In some embodiments, a plurality of peel layers may be disposed adjacent to one another, the plurality of peel layers including the same materials or including at least one different material.

The polycarbonate component of the optical film may exhibit a set of desirable properties. For example, the polycarbonate layer may have an optical haze as measured by a hazemeter of less than 1%, less than 0.5%, less than 0.25%, or even less than 0.1%. In some embodiments, bulk haze (scattering in the volume of the polycarbonate layer versus surface scattering) is desirable to minimize, while a certain level of surface scattering may be acceptable or even designed for, for example, the purpose of defect hiding. In such application, the bulk haze may be measured by “wetting out” any surface structure with an approximately index-matched (within, for example 5% of the index of refraction of the polycarbonate layer) fluid or other material having an optically smooth outer surface before measuring with a hazemeter. Similarly, in such cases, the polycarbonate layer may have a bulk optical haze as measured by a hazemeter of less than 1%, less than 0.5%, less than 0.25%, or even less than 0.1%.

In some embodiments, the polycarbonate layer has an average in-plane retardance of less than 50 nm, less than 25 nm, less than 20 nm, less than 15 nm, less than 10 nm, less than 5 nm, or even less than 1 nm. In some embodiments, the polycarbonate layer has an average out-of-plane retardance magnitude of less than 75 nm, less than 70 nm, less than 50 nm, or even less than 40 nm. The retardance values may be measured at a certain wavelength: for example, for purposes of the present description the retardance values were measured at 590 nm. However, it is expected that the low retardance values would be valid over a range of wavelengths. Finally, the polycarbonate layer may be thin in some embodiments: less than 50 μm, less than 40 μm, less than 30 μm, or even less than 20 μm. Films are extraordinarily difficult to handle below 10 μm, and so this can be considered the lower thinness bound for polycarbonate layers described herein, unless a peel layer is used as a carrier layer throughout all downstream processes until application in a final product. In such cases, the polycarbonate layer may be less than 10 μm, for example, between 1 μm and 10 μm thick.

Polycarbonates used herein have a high molecular weight. In some embodiments, the polycarbonate has an average molecule weight of at least 20,000. In some embodiments, the polycarbonate has an average molecular weight of at least 25,000. In some embodiments, the polycarbonate has an average molecular weight of at least 28,000. In some embodiments, the polycarbonate has an average molecular weight of at least 30,000. All given molecular weight averages are weight averages.

The additional layer may be on the casting wheel side or the non-casting wheel side of the film. In some embodiments, the presence of the peel layer on the casting wheel (and perhaps the subsequent roll contact side) may absorb certain shear forces exerted on the optical film instead of affecting the polycarbonate layer, allowing the polycarbonate layer to remain substantially haze free and optically isotropic.

FIG. 2 is an alternative bilayer optical film, where optical film 200 includes polycarbonate layer 210 and additional layer 220. Additional layer 220 may be compositionally different than the analogous peel layer 120 in FIG. 1, as additional layer 220 is not necessarily intended to be peelable or removable from the rest of optical film 200. Instead, additional layer 220 may impart various physical and optical characteristics to optical stack 200. For example, additional layer 220 may include an ultraviolet light absorber or a material that enhances the optical film's chemical resistance. In some embodiments, this material may be or include a co-polyethylene naphthalate (coPEN). An exemplary coPEN that may be used in this application is a copolyester including 100 mol % naphthalate moieties on an esters basis with 70 mol % ethylene glycol moieties and 30 mol % cyclohexanedimethanol moieties on a diols basis. This coPEN will be referred to as PENg30.

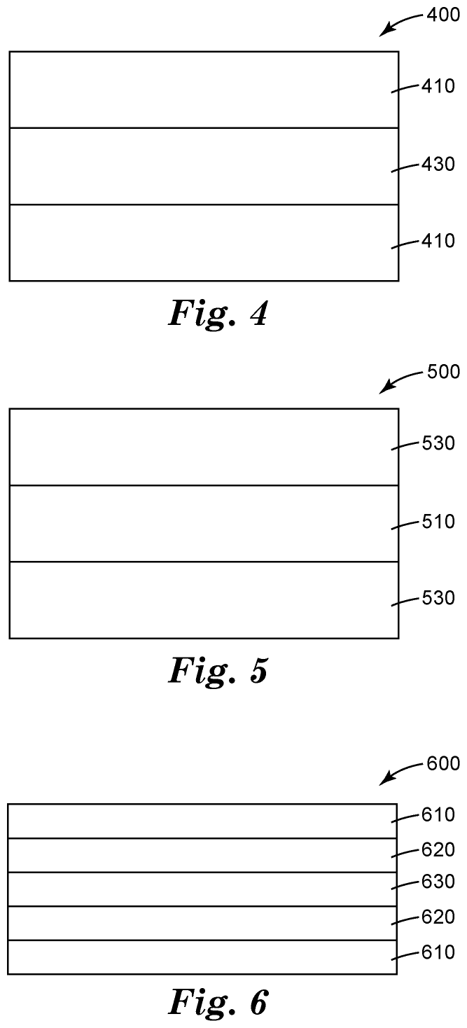

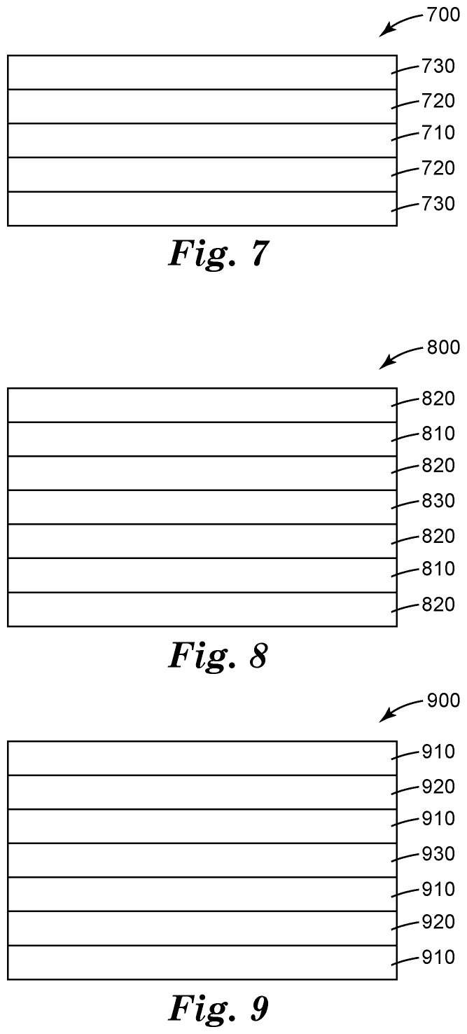

FIGS. 3-9 are essentially variations, expansions, or alternative arrangements of the layers described elsewhere. For example, FIG. 3 shows three-layer optical film 300 including polycarbonate layer 310, additional layer 320, and peel layer 330. FIG. 4 shows three-layer optical film 400 including polycarbonate layers 410 and peel layer 430. FIG. 5 shows three-layer optical film 500 including polycarbonate layer 510 and peel layers 530. FIG. 6 shows five-layer optical film 600 including polycarbonate layers 610, additional layers 620, and peel layer 630. FIG. 7 shows five-layer optical film 700 including polycarbonate layer 710, additional layers 720, and peel layers 730. FIG. 8 shows seven-layer optical film 800 including polycarbonate layers 810, additional layers 820, and peel layer 830. FIG. 9 shows seven-layer optical film 900 including polycarbonate layers 910, additional layers 920, and peel layer 930. The exemplary configurations illustrated are a subset of the possible constructions and can be expanded or modified by the skilled person depending on manufacturing, application, or other types of considerations.

### EXAMPLES

The following examples demonstrate several means of making relatively thin, haze-free optical films having low birefringence that are also robust to bending cycles. The fabrication method of using a co-extrusion process to form the optical film (or films) with a carrier substrate provides both dimensional stability and one or more of an additional layer and a peel layer, but is not to be considered limiting to the scope of this application. The examples show methods to fabricate and separate either individual layers or bilayers from a multilayer co-extrusion process. The measurements of film quality are demonstrated for the resulting examples by both conventional optical metrics as well as bending failure life.

For purposes of concisely describing a variety of example fabrication concepts, 3 types of layers are generically labelled as A, B and C. The A layer materials used in these many-layered films serve as a high Tg (147° C.), isotropic substrate with excellent physical properties; for example, polycarbonate. The B layer materials in these many-layered films can also be polycarbonate, but may also be CoPEN polyester for preferred solvent resistance and UV blocking characteristics. An exemplary CoPEN is PENg30. The C layer materials in these many-layered films are preferably a blend of either a polypropylene or co-polypropylene (at least 70 wt %) with an SEBS/SEPS block copolymer. The C layer may also optionally contain olefinic anti-stat agent capable of co-extruding with these materials to enhance electrostatic pinning in the film casting process. The C (peel) layer is designed to provide approximately 5 to 40 grams of peel force adhesion per inch of film width between the B and C layers. The specific composition details for each example follow.

### Materials

TABLE 1

| Trade Designation | Description | Supplier |
|---|---|---|
| IUPILON E-2000 | Polycarbonate (PC) | Mitsubishi Engineering- |
| | | Plastics, Tokyo, JP |
| IUPILON HL-4000 | Polycarbonate (PC) | Mitsubishi Engineering- |
| | | Plastics, Tokyo, JP |
| PRO-FAX SR549M | Co-propylene (7% | Lyondell-Basell, Houston, |
| | polyethylene) | TX |
| EASTSTAR GN071 | Co-Polyester (PETg) | EASTMAN, Kingsport, TN |
| KRATON G1645 | SEBS/SEPS block | KRATON, Belpre, Ohio |
| | copolymer | |
| KRATON G1657 | SEBS/SEPS block | KRATON, Belpre, Ohio |
| | copolymer | |
| PELESTAT 230 | Antistat resin | Sanyo Chemical Industries |

### Test Methods

### Optical Measurements

The conventional optical measurements of transmission, haze and clarity were conducted on BYK Gardner HAZE-GARD PLUS instrument with all the strippable layers removed. Optical polarization retardation measurements were made using an Axometrics AXOSCAN spectral Mueller matrix polarimeter. The AXOSCAN derives RO from a normal incidence spectral scan over 420-700 nm wavelength range and Rth from a set of tilt measurements about the optical “fast” and “slow” axis at wavelength=589 nm. The AXOSCAN calculates Rth per the following equation:

Rth=((nx+ny)/2−nz)d; where d=film thickness.

### Dynamic Folding Test

The durability of the protective films to multiple folding events was evaluated using a dynamic fold tester. The dynamic fold tester has two coplanar plates with parallel pivot axes where both plates can rotate by 90 degrees to face each other. The gap between the plates when closed was set to approximately 8 mm, thereby making the bend radius approximately 4 mm. 7″×1.5″ pieces of each sample were converted using mechanical cutter. Two replicates of each sample construction were attached to the folding plates using 1.5″ wide strips of a double sided tape. The tape was applied to the plates such that there was a free zone approximately 15 mm (3 times the bend radius) wide on either side of the folding axis where the film was unconstrained.

For each example film tested there were 4 folding orientations tested correlated to the orientations of the film as it had been made in the co-extrusion process.
1. Fold in extrusion machine direction (MD) with side 1 (PC side) out
2. Fold in extrusion machine direction (MD) with side 2 (side opposite PC side) out
3. Fold in extrusion transverse direction (TD) with side 1 (PC side) out
4. Fold in extrusion transverse direction (TD) with side 2 (side opposite PC side) out

The dynamic folding test results are reported for each sample in each of these 4 orientations and with two replicates per example/orientation (i.e. 1 TD and 2 TD are first and second samples tested in orientation from transverse direction of the extrusion machine). The dynamic folding failure testing is somewhat sensitive to setup and variability and confidence of results is improved with additional replicates.

The folding rate was set to approximately 30 folds/min and the test run for 200,000 cycles or until all the samples had failed. The samples were visually inspected approximately every 1000 cycles for the first 10,000 cycles and approximately every 5,000-10,000 cycles up to 100,000 folds and then between 10,000 and 25,000 cycles up to 200,000 folds for evidence of failure such as coating cracking, delamination or haze. When the sample evidenced any of these visual defect types it was designed as failed and the folding stopped.

### Delamination Peel Force Testing

These measurements were conducted using a IMASS SP-2100 from IMASS, Inc, Accord, MA with the base film taped to a rigid flat glass plate. The conditions for this measurement were as follows: 90 degree peel; 60 inches/minute slide speed; and the peel force was averaged over the travel distance of the peel. The resulting peel force values, given in grams/inch.

### Film Thickness, Index of Refraction

Film thickness and index of refraction were measured with model 2010/M prism coupler from Metricon with a 633 nm laser source.

### Co-Extrusion Process

The many-layered film articles produced for these examples used a 16 layer concept on coextrusion equipment to produce the layer structure of (ABC/ABC/ABC/ABC/ABC/A) to compose 5 layer packets plus a base layer. This 16 layer concept worked well to produce very thin layers of film which were subsequently separated to yield (5) very thin flat tri-layer films consisting of ABC layer packets. The peel-able layer (C) was removed prior to subsequent measurements for each of the examples.

The (A) layers were produced by extruding resins through a 25 mm twin screw extruder (TSE), through a neck tube and gear pump into the A layers of the 16-layer feed block and die. This melt train used a progressive temperature extrusion profile, with peak temperatures of ˜305° C. The intermediate (B) layers were produced by extruding the above-identified resins through a 27 mm TSE with a progressive temperature profile peaking at or around 285° C. through a neck tube and gear pump into the 16-layer feed block and die. The core (C) layers were produced by extruding the above-identified resin through an 18 mm TSE through a neck tube and gear pump into the 16-layer feed block and die. Once again, a progressive temperature profile was used with peak temperatures of 290° C. The feed block/die was held at a target temp of 285° C. while the casting chill wheel was run at about 120 to 160° C. Cast webs were electrostatically pinned to the chill wheel and 16 layer films of 12 to 24 mils were produced for each material set film example. All TSE's consisted of one or more barrel zones designed to pull vacuum and devolatize as to eliminate the requirement of resin pellet drying. Feed rates were adjusted to adjust layer thicknesses.

### Example Description

TABLE 2

| | A layer | B layer | C Layer | Thickness | Index | Thickness | Index | Thickness |
|---|---|---|---|---|---|---|---|---|
| Example | resin | resin | resin | A [μm] | A | B [μm] | B | total [μm] |
| 1 | PC | PENg30 | PP/Kraton | 36.1 | 1.579 | 21.8 | 1.626 | 57.9 |
| | | | (90/10) | | | | | |
| 2 | PC | PENg30 | PP/Kraton | 22.4 | 1.579 | 17.4 | 1.626 | 39.8 |
| | | | (90/10) | | | | | |
| 3 | PC | PENg30 | PP/Kraton | 19.7 | 1.579 | 12.2 | 1.625 | 31.9 |
| | | | (90/10) | | | | | |
| 4 | PC | PENg30 | PP/Kraton | 30.2 | 1.579 | 38.8 | 1.625 | 69.0 |
| | | | (90/10) | | | | | |
| 5 | PC | PENg30 | PP/Kraton | 23 | 1.579 | 30.8 | 1.626 | 53.8 |
| | | | (90/10) | | | | | |
| 6 | PC | PENg30 | PP/Kraton | 13.3 | 1.579 | 20.1 | 1.626 | 33.4 |
| | | | (90/10) | | | | | |
| 7 | PC | PETg | PP/Kraton | 38.1 | 1.578 | 25.3 | 1.564 | 63.4 |
| | | | (90/10) | | | | | |
| 8 | PC | PETg | PP/Kraton | 29.9 | 1.579 | 21.5 | 1.565 | 51.4 |
| | | | (90/10) | | | | | |
| 9 | PC | PETg | PP/Kraton | 19.4 | 1.578 | 12.9 | 1.564 | 32.3 |
| | | | (90/10) | | | | | |
| 10 | PC | PC | PP/Kraton | | 1.58 | | | 29.0 |
| | | | (90/10) | | | | | |
| 11 | PC | PC | PP/Kraton | | 1.58 | | | 53.9 |
| | | | (90/10) | | | | | |

The PENg30 material for these examples is copolyester comprised of 100 mol % naphthalate moieties on and esters bases with 70% ethylene glycol moieties and 30% cyclohexanedimethanol moieties on a diols basis. The PETg material for these examples is Eaststar GN071 material from Eastman. The Kraton material used for these examples is commercially available as Kraton 1645.

As the films were peeled apart, the resulting films for measurements were composed of either individual films of PC (examples 10, 11) or bilayer films of PC+PENg (examples 1-6) or PC+PETg (examples 7-9). The measured peel force between the PC and PENg30 layers exceeds 100 Win (adhesion force per film width in inches) while the peel force between the PENg30 and SR549/Kraton blends registered at 5-10 g/in (adhesion force per film width in inches).

### Comparative Example 1, 2 (CE-1, CE-2)

A low viscosity, high melt flow PC resin, IUPILON HL-4000 from Mitsubishi Engineering-Plastics, Tokyo, Japan was extruded and produced into a film like examples 1-9 to compare failure rate in dynamic bend fatigue testing vs the higher viscosity, low melt flow PC resin, IUPILON E-2000 from Mitsubishi Engineering-Plastics, Tokyo, Japan. It is understood, by those familiar in the art, that the molecular weight of the polycarbonate affects both residual stress and brittleness of the resulting films. Making films from low viscosity/low molecular weight polycarbonate tends to relax film stress and reduced optical retardation measurements, but generally results in poorer dynamic bend fatigue testing results and increased brittleness. Our comparatives examples were drawn from commercially available polycarbonates with the following properties:

TABLE 3

| | | | GPC light scattering | | GPC against PS | |
|---|---|---|---|---|---|---|
| | | | Mn | Mw | Mn | Mw |
| | | | (Number | (weight | (Number | (weight |
| | | | of avg. | average | of avg. | average |
| | | Melt-Flow | molecular | molecular | molecular | molecular |
| Example | material | [cm\hat{ }3/10 min] | weight) | weight) | weight) | weight) |
| CE-1 | Iupilon | 60 | 10,300 | 15,700 | 7,950 | 28,400 |
| | HL-4000 | | | | | |
| CE-2 | Iupilon | 5 | 20,800 | 30,000 | 12,700 | 54,600 |
| | E-2000 | | | | | |

### Optical Measurement Results

TABLE 4

| | Thickness | Transmission | Haze | Clarity | R0 [nm] at | Rth [nm] at |
|---|---|---|---|---|---|---|
| Example | total [μm] | [%] | [%] | [%] | 590 nm | 590 nm |
| 1 | 57.9 | 92.3 | 0.45 | 99.7 | 10.9 | 67 |
| 2 | 39.8 | 92.1 | 0.38 | 98 | 1.2 | 46 |
| 3 | 31.9 | 92.2 | 0.76 | 99.8 | 1.0 | 38 |
| 4 | 69.0 | 91.5 | 0.91 | 98.9 | 3.8 | 88 |
| 5 | 53.8 | 91.6 | 0.89 | 99.7 | 3.9 | 92 |
| 6 | 33.4 | 92.8 | 1.5 | 99.8 | 1.0 | 61 |
| 7 | 63.4 | 92.9 | 0.37 | 99.5 | 0.5 | 30 |
| 8 | 51.4 | 93.2 | 0.34 | 99.7 | 5.3 | 38 |
| 9 | 32.3 | 93.1 | 0.42 | 99.8 | 0.5 | 24 |
| 10 | 29.0 | 93.0 | 0.38 | 99.5 | 2.36 | 6 |
| 11 | 53.9 | 92.8 | 0.33 | 96.7 | 7.35 | 35 |

### Dynamic Folding Results

TABLE 5

| | | | Failure [folding cycles] | | | | | |
|---|---|---|---|---|---|---|---|---|
| | | Extrusion | Before | 10K- | 50K- | 100K- | 150K- | |
| Example | “Out” | Direction | 10K | 50K | 100K | 150K | 200K | >200K |
| 1 | Side 1 | 1 MD | | X | | | | |
| 1 | | 2 MD | | | X | | | |
| 1 | | 1 TD | | | | | | X |
| 1 | | 2 TD | | | | | X | |
| 1 | Side 2 | 1 MD | | X | | | | |
| 1 | | 2 MD | | X | | | | |
| 1 | | 1 TD | | X | | | | |
| 1 | | 2 TD | | | X | | | |
| 2 | Side 1 | 1 MD | | | | | X | |
| 2 | | 2 MD | | | | | | X |
| 2 | | 1 TD | | | | | | X |
| 2 | | 2 TD | | | | | | X |
| 2 | Side 2 | 1 MD | | | | | | X |
| 2 | | 2 MD | | | | | X | |
| 2 | | 1 TD | | X | | | | |
| 2 | | 2 TD | | | | | | X |
| 3 | Side 1 | 1 MD | | | X | | | |
| 3 | | 2 MD | | | | | X | |
| 3 | | 1 TD | | | X | | | |
| 3 | | 2 TD | | | | | X | |
| 3 | Side 2 | 1 MD | | | X | | | |
| 3 | | 2 MD | | | | | | X |
| 3 | | 1 TD | | | | | | X |
| 3 | | 2 TD | | | | | X | |
| 4 | Side 1 | 1 MD | | | | X | | |
| 4 | | 2 MD | | | | | X | |
| 4 | | 1 TD | | X | | | | |
| 4 | | 2 TD | | X | | | | |
| 4 | Side 2 | 1 MD | | | X | | | |
| 4 | | 2 MD | | X | | | | |
| 4 | | 1 TD | | | X | | | |
| 4 | | 2 TD | | | X | | | |
| 5 | Side 1 | 1 MD | | | X | | | |
| 5 | | 2 MD | | | | X | | |
| 5 | | 1 TD | | X | | | | |
| 5 | | 2 TD | | X | | | | |
| 5 | Side 2 | 1 MD | | X | | | | |
| 5 | | 2 MD | | | X | | | |
| 5 | | 1 TD | | | | | X | |
| 5 | | 2 TD | | X | | | | |
| 6 | Side 1 | 1 MD | | X | | | | |
| 6 | | 2 MD | | | X | | | |
| 6 | | 1 TD | | | | X | | |
| 6 | | 2 TD | | | X | | | |
| 6 | Side 2 | 1 MD | | | | | | X |
| 6 | | 2 MD | | | | | | X |
| 6 | | 1 TD | | | | X | | |
| 6 | | 2 TD | | | | | | X |
| 7 | Side 1 | 1 MD | | X | | | | |
| 7 | | 2 MD | | X | | | | |
| 7 | | 1 TD | | X | | | | |
| 7 | | 2 TD | | X | | | | |
| 7 | Side 2 | 1 MD | | | | | X | |
| 7 | | 2 MD | | | | | | X |
| 7 | | 1 TD | | | X | | | |
| 7 | | 2 TD | | | | | | X |
| 8 | Side 1 | 1 MD | | X | | | | |
| 8 | | 2 MD | | X | | | | |
| 8 | | 1 TD | | | X | | | |
| 8 | | 2 TD | | | | X | | |
| 8 | Side 2 | 1 MD | | | | | | X |
| 8 | | 2 MD | | | | | | X |
| 8 | | 1 TD | | | | | | X |
| 8 | | 2 TD | | | | | | X |
| 9 | Side 1 | 1 MD | | | | | | X |
| 9 | | 2 MD | | | | X | | |
| 9 | | 1 TD | | | | | X | |
| 9 | | 2 TD | | | | | | X |
| 9 | Side 2 | 1 MD | | | X | | | |
| 9 | | 2 MD | | | | | | X |
| 9 | | 1 TD | | | | X | | |
| 9 | | 2 TD | | | | | | X |
| 10 | Side 1 | 1 MD | | | | | | X |
| 10 | | 2 MD | | | | | | X |
| 10 | | 1 TD | | | | | | X |
| 10 | | 2 TD | | | | | | X |
| 11 | Side 1 | 1 MD | | | | | | X |
| 11 | | 2 MD | | | | | | X |
| 11 | | 1 TD | | | X | | | |
| 11 | | 2 TD | | | X | | | |
| CE-1 | | 1 MD | | | >50K* | | | |
| CE-1 | | 2 MD | | X | | | | |
| CE-1 | | 1 TD | | | >50K* | | | |
| CE-1 | | 2 TD | | | >50K* | | | |
| CE-2 | | 1 MD | X | | | | | |
| CE-2 | | 2 MD | | X | | | | |
| CE-2 | | 1 TD | X | | | | | |
| CE-2 | | 2 TD | X | | | | | |

For example, replicates 1MD and 2MD are first and second sample tested in Machine Direction (MD) from the sourcing extrusion equipment. Replicates 1 TD and 2 TD are first and second samples testing in Transverse Direction (TD) from the sourcing extrusion equipment. Asterisk indicates those tests on comparative examples were only run to 50K and showed no failures to that point; these tests did not run to full 200K folding cycles that the examples were subjected to.

The present invention should not be considered limited to the particular examples and embodiments described above, as such embodiments are described in detail in order to facilitate explanation of various aspects of the invention. Rather, the present invention should be understood to cover all aspects of the invention, including various modifications, equivalent processes, and alternative devices falling within the scope of the invention as defined by the appended claims and their equivalents.

1. An optical film, comprising:
a layer of polycarbonate having first and second major surfaces;
wherein the layer is between 10 and 50 micrometers thick;
wherein the optical film, with any peel layers removed, has an average haze less than 0.5%;
wherein the optical film, with any peel layers removed, has an average in-plane retardance of less than 25 nm;
wherein the optical film, with any peel layers removed has an average out-of-plane retardance of less than 75 nm; and
wherein the polycarbonate has a molecular weight greater than 20,000.

2. The optical film of claim 1, wherein at least the first major surface or the second major surface is exposed to air.

3. The optical film of claim 1, further comprising a protective layer not including polycarbonate disposed on the first major surface.

4. The optical film of claim 3, wherein the protective layer includes polyethylene naphthalate or co-polymers or blends thereof.

5. The optical film of claim 4, wherein the protective layer increases the chemical resistance or the UV absorption of the optical film.

6. The optical film of claim 3, wherein the protective layer includes a polypropylene or a copolymer or blend thereof.

7. The optical film of claim 1, further comprising a first protective layer disposed on the first major surface and a second protective layer disposed on the second major surface, the first and second protective layers not including polycarbonate.

8. The optical film of claim 7, wherein the first protective layer and the second protective layer are the same material.

9. The optical film of claim 7, wherein, the first protective layer and the second protective layer are different materials.

10. A multilayer optical film, comprising a plurality of the optical films of claim 1, wherein each adjacent pair of the plurality of optical films is separated by a protective layer not including polycarbonate.

11. The multilayer optical film of claim 10, wherein each adjacent pair of the plurality of optical films is further separated by a second protective layer not including polycarbonate.

12. A multilayer optical film, comprising a plurality of the optical films of claim 1 and at least one of a first protective layer and at least one of a second protective layer each of the first protective layer and the second protective layer not including polycarbonate, wherein the plurality of optical films, the at least one of a first protective layer, and the at least one of a second protective layer are configured such that any two of the plurality of optical films are not directly adjacent.

13. The optical film of claim 1, wherein the optical film has its first and second major surfaces exposed to air, and the optical film fails in a dynamic folding tester not before more than 10,000 cycles.

14. The optical film of claim 13, wherein the optical film fails in a dynamic folding tester not before more than 30,000 cycles.

15. The optical film of claim 14, wherein the optical film fails in a dynamic folding tester not before more than 50,000 cycles.

16. An emissive display element, comprising the optical film of claim 1.

17. The emissive display element of claim 16, wherein the emissive display element is flexible.

18. A display device, comprising the optical film of claim 1.

19. The display device of claim 18, wherein the display device is flexible.

20. A roll of film, comprising the optical film of claim 1.
